(19) United States
(12) Patent Application Publication
(10) Pub. No.: US 2026/0307426 A1
(43) Pub. Date: Oct. 8, 2026

(54) File

(71) Applicant: King Jim Co., Ltd., Tokyo (JP)

(72) Inventor: Yurino Sasaki, Tokyo (JP)

(21) Appl. No.: 19/482,310

(22) PCT Filed: Jan. 15, 2024
(86) PCT No.: PCT/JP2024/000727

§ 371 Date: Nov. 7, 2025

(30) Foreign Application Priority Data
May 11, 2023 (JP) 2023-078829

(51) Int. Cl. B42F 7/08

(52) U.S. Cl. CPC B42F 7/08

(57) ABSTRACT

A file includes a holding sheet body including a sheet section extended in one direction and including a holding section configured to cause the sheet section to hold an object to be held, a first cover body to which one end in an extending direction of the sheet section is connected, a second cover body to which the other end in the extending direction of the sheet section is connected, and a first engaging section configured to engage the first cover body and the second cover body. The first engaging section includes a moving mechanism configured to enable relative movement of the first cover body and the second cover body to change the distance between a connection part of the holding sheet body in the first cover body and a connection part of the holding sheet body in the second cover body.

### TECHNICAL FIELD

The present invention relates to a foldable file.

### BACKGROUND ART

Patent Document 1 describes a document file in which a transparent pocket is folded in a zigzag manner (accordion-folded). In Patent Document 1, a crease is formed at a bent section to allow the transparent pocket to be folded in a zigzag manner and the transparent pocket is attached to a cover, the crease of the bent section of the transparent pocket is formed on the inner side and the outer side is formed as an opening, and creases, cover lids, and fasteners are formed on each of the covers on both sides. Accordingly, the document file of Patent Literature 1 makes it possible to uniformly spread only a necessary part while keeping an unnecessary part folded.

### CITATION LIST

### Patent Document

Patent document 1: Japanese Utility Model Laid-Open No. Sho 58-168464
Patent document 2: Japanese Utility Model Laid-Open No. Sho 59-7880
Patent document 3: Japanese Utility Model Laid-Open No. Sho 63-191073
Patent document 4: Japanese Utility Model Publication No. Hei 1-8383
Patent document 5: Japanese Utility Model Laid-Open No. Sho 61-188878

### SUMMARY

### Technical Problem

In the document file of Patent document 1, although the transparent pocket can be spread and viewed, it is difficult to use the document file in such a manner as to turn the pages one by one like a booklet-like file in a state in which the transparent pocket is folded in a zigzag manner, and there is room for improvement in convenience.

An object of the technology of the present disclosure is to provide a technology for, in a file capable of transitioning to an expanded state and a folded state, improving convenience in the folded state.

### Means for Solving the Problems

In order to solve the problem described above, a file of the present disclosure is a file including:
a holding sheet body including a sheet section extended in one direction and including a holding section configured to cause the sheet section to hold an object to be held;
a first cover body to which one end in an extending direction of the sheet section is connected;
a second cover body to which another end in the extending direction of the sheet section is connected; and
a first engaging section configured to engage the first cover body and the second cover body, wherein
a plurality of creases are provided in the sheet section in the extending direction, the plurality of creases extending in a direction orthogonal to the extending direction and along a surface that holds the object to be held, and the sheet section is capable of transitioning to a folded state of being folded like a bellows in the creases and an expanded state of being expanded with the creases folded back,
the first cover body includes a main cover section capable of closing along the holding sheet body in the folded state and a sub-cover section capable of opening and closing relatively to the main cover section, and
the first engaging section engages the second cover body and the sub-cover section in a state in which the sub-cover section is placed along the second cover body, and
the first engaging section includes a moving mechanism configured to enable relative movement of the first cover body and the second cover body to change a distance between a connection part of the holding sheet body in the first cover body and a connection part of the holding sheet body in the second cover body.

The first engaging section may disengageably engage the first cover body and the second cover body.

In the file,
the second cover body may include a main cover section capable of closing along the holding sheet body in the folded state and a sub-cover section capable of opening and closing relatively to the main cover section, and
the file may include a second engaging section configured to engage the second cover body and the first cover body in a state in which the sub-cover section of the second cover body is placed along the main cover section of the first cover body.

In the file,
the second engaging section may include a second engaging member configured to engage the second cover body and the first cover body, and
the moving mechanism may include a slide groove provided in the sub-cover section in the second cover body in a width direction of the sub-cover section in the second cover body and configured to slidably hold the second engaging member.

In the file,
the first engaging section may include a first engaging member configured to engage the second cover body and the first cover body, and
the moving mechanism may include a slide groove provided in the sub-cover section in the first cover body in a width direction of the sub-cover section in the first cover body and configured to slidably hold the first engaging member.

### Advantageous Effects

According to the technology of the present disclosure, it is possible to provide a technology for, in a file capable of transitioning to an expanded state and a folded state, improving convenience in the folded state.

### BRIEF DESCRIPTION OF THE DRAWINGS

FIG. 1 is a perspective view of a file according to an embodiment.

FIG. 2 is afront view of the file.

FIG. 3 is a right side view of the file.

FIG. 4 is a plan view of the file.

FIG. 5 is a bottom view of the file.

FIG. 6 is a rear view of the file.

FIG. 7 is a left side view of the file.

FIG. 8 is a diagram illustrating a cover body outer side surface in the case in which the file is opened in a state in which a first cover section of a first cover body and a third cover section of a second cover body are engaged.

FIG. 9 is a diagram illustrating the cover body outer side surface in the case in which the file is opened in a state in which a first cover section of the second cover body and a third cover section of the first cover body are engaged.

FIG. 10 is a plan view illustrating the periphery of a hinge of the first cover body.

FIG. 11 is a schematic sectional view illustrating the vicinity of an attachment position of a convex button of the first cover body and a concave button of the second cover body.

FIG. 12 is a schematic sectional view illustrating the vicinity of an attachment position of a convex button of the second cover body and a concave button of the first cover body.

FIG. 13 is a diagram illustrating an expanded state of a holding sheet body.

FIG. 14 is a diagram illustrating the file halfway in expansion.

FIG. 15 is a schematic sectional view in the vicinity of a holding section illustrating a state in which an object to be held is held.

FIG. 16 is a diagram illustrating the file changed from a state in which the file is closed to a state in which the second cover body is opened.

FIG. 17 is a diagram illustrating a state in which the holding sheet body is opened in double-page spread.

FIG. 18 is a diagram illustrating a state in which the first cover body and the second cover body are disengaged and the holding sheet body is expanded.

FIG. 19 is a diagram illustrating a state in which the first cover body and the second cover body are relatively moved by a moving mechanism.

FIG. 20 is a diagram illustrating a state before the first cover body and the second cover body are relatively moved by the moving mechanism when the file is opened.

FIG. 21 is a diagram illustrating a state after the first cover body and the second cover body are relatively moved by the moving mechanism when the file is opened.

FIG. 22 is a diagram illustrating a configuration of a file according to a modification 1.

FIG. 23 is a diagram illustrating a configuration of a file according to a modification 2.

FIG. 24 is a diagram illustrating a state in which the inner side (a side where the holding sheet body is provided) of the file according to the modification 2.

FIG. 25 is a diagram illustrating an outer side surface (a second surface) in the case in which the file according to the modification 2 is opened.

FIG. 26 is a perspective view illustrating a state halfway in undoing a button pair of the file according to the modification 2 to expand the file.

### DESCRIPTION OF EMBODIMENTS

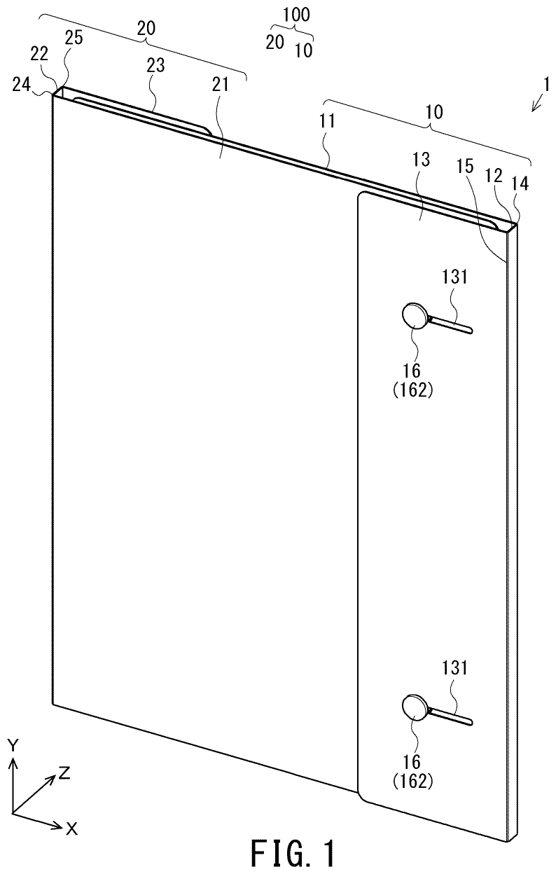

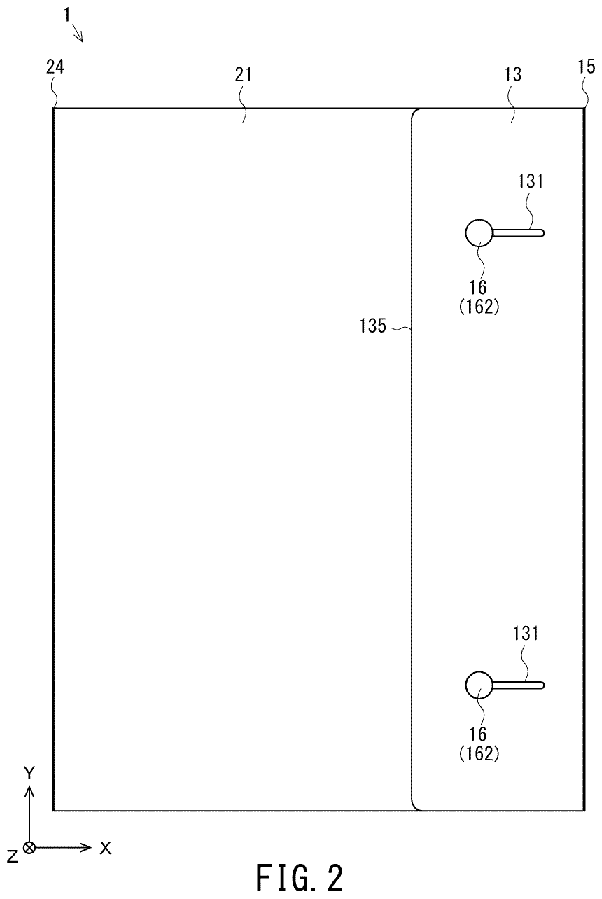

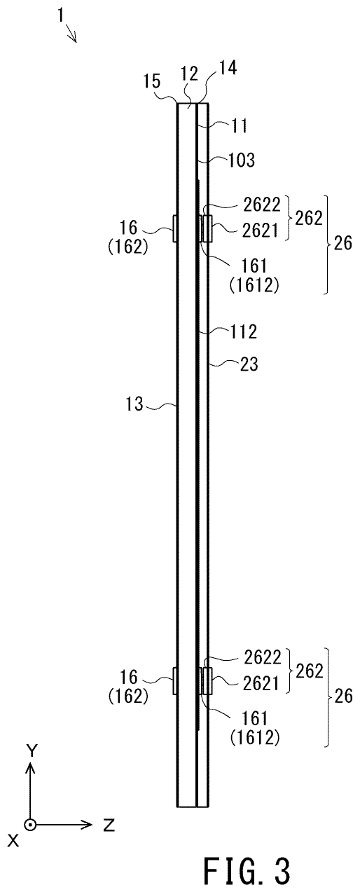

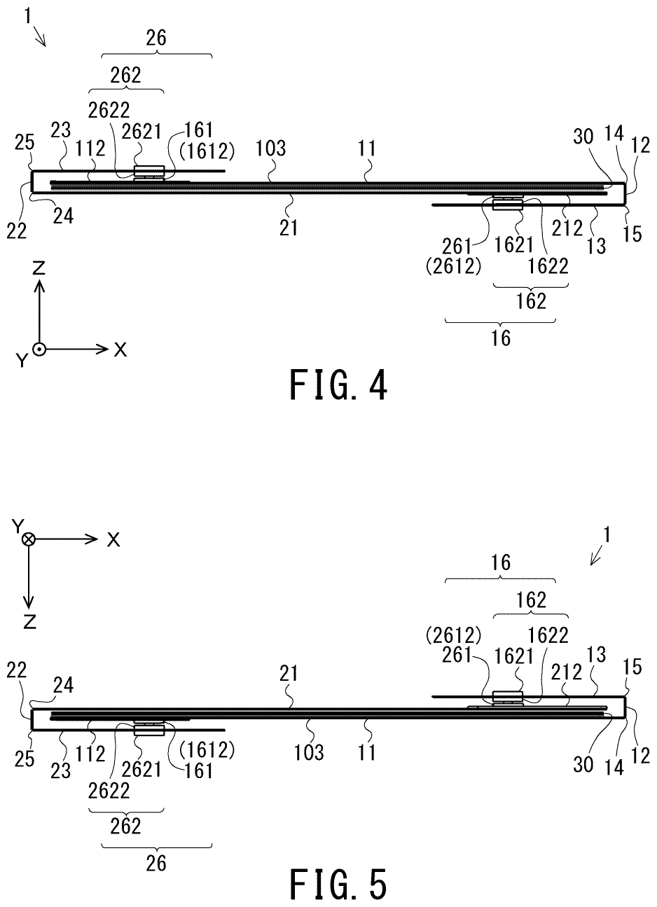

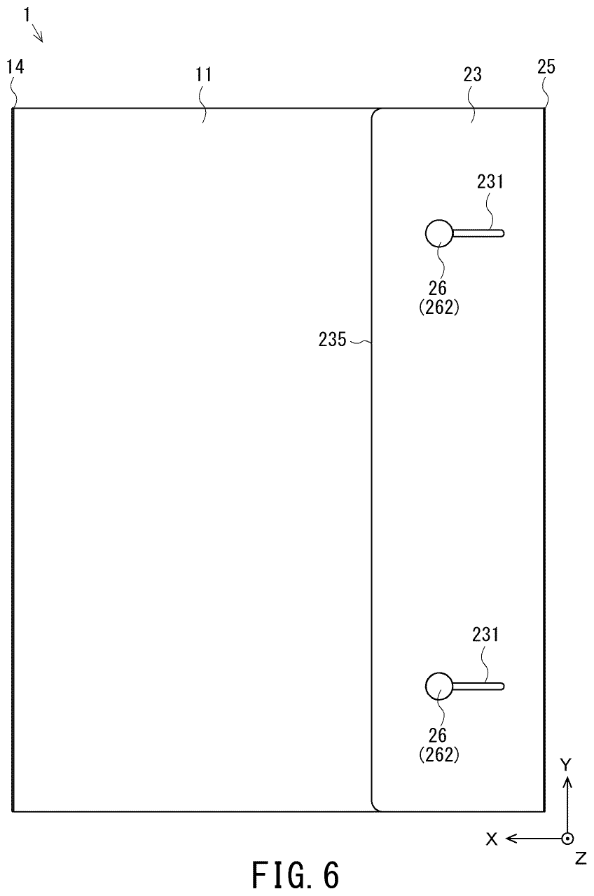

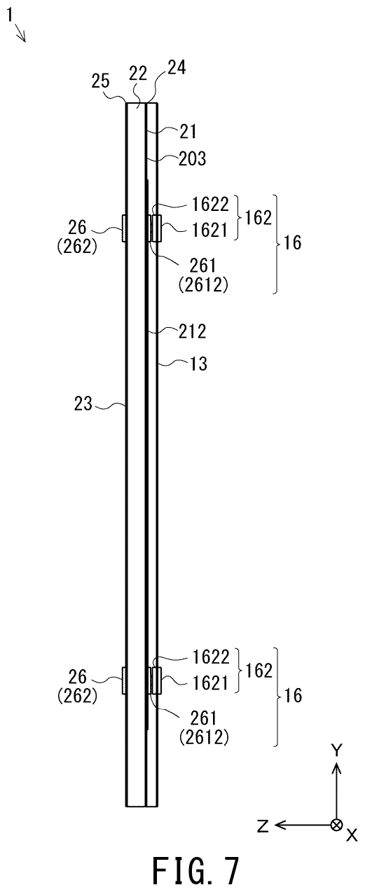

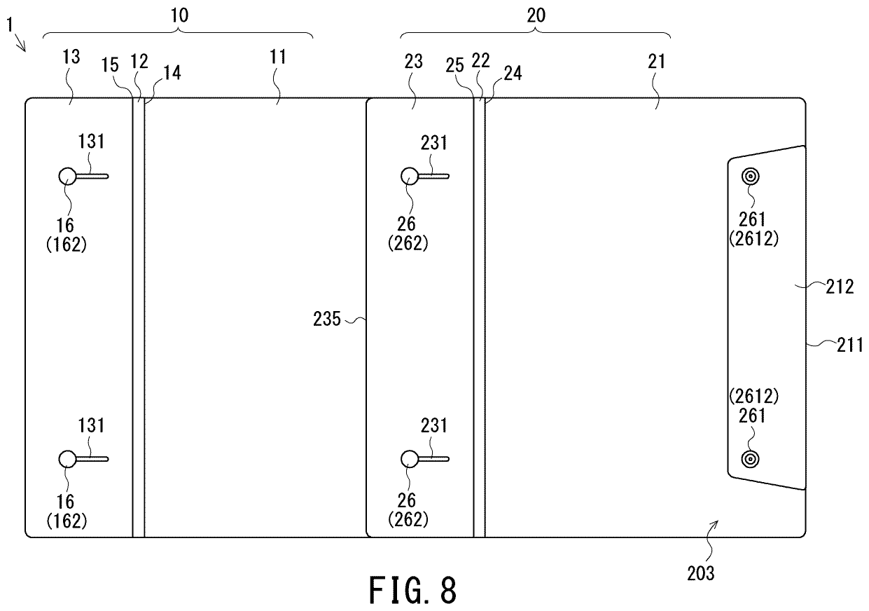

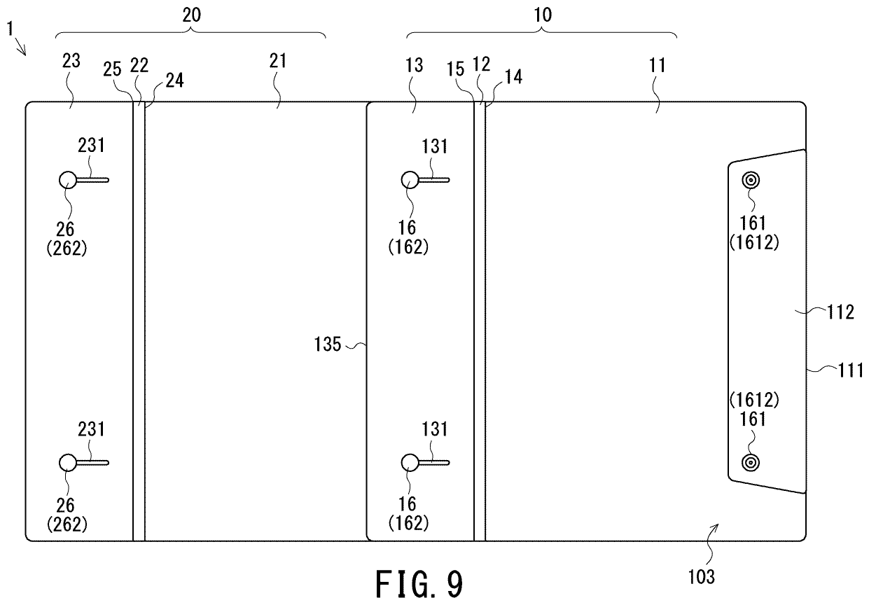

An embodiment of the present invention is described with reference to the drawings. A configuration in the embodiment described below is exemplification, and the present invention is not limited to the configuration in the embodiment. FIG. 1 is a perspective view of a file 1 according to the present embodiment, FIG. 2 is a front view of the file 1, FIG. 3 is a right side view of the file 1, FIG. 4 is a plan view of the file 1, FIG. 5 is a bottom view of the file 1, FIG. 6 is a rear view of the file 1, FIG. 7 is a left side view of the file 1, FIG. 8 is a diagram illustrating a cover body outer side surface in the case in which the file is opened in a state in which a first cover section of a first cover body and a third cover section of a second cover body are engaged, and FIG. 9 is a diagram illustrating the cover body outer side surface in the case in which the file is opened in a state in which a first cover section of the second cover body and a third cover section of the first cover body are engaged. Note that, in the present embodiment, the up-down direction (a Y-axis direction) in FIG. 1 is represented as “the up-down direction of the file”, the left-right direction (an X-axis direction) in FIG. 1 is represented as “the left-right direction of the file”, and the direction perpendicular to the paper surface (a Z-axis direction) in FIG. 1 is represented as “the depth direction of the file”. Note that these directions are illustrated as examples for convenience of description according to the present embodiment and are not limited to this. Note that the length in the up-down direction is referred to as “height” as well and the length in the left-right direction is referred to as “width” as well. The file 1 includes a cover body 100 and a holding sheet body 30. The cover body 100 includes a first cover body 10 and a second cover body 20 configured to be engageable with and disengageable from each other. The file 1 can hold a sheet-like object to be held such as a document, a musical score, or a photograph in the holding sheet body 30. In the file 1, in a state in which the first cover body 10 and the second cover body 20 are engaged as illustrated in FIG. 1 to FIG. 7, the first cover body 10 and the second cover body 20 surround the outer periphery of the holding sheet body 30 and protect the object to be held held by the holding sheet body 30. In the file 1 in the present embodiment, by disengaging the first cover body 10 and the second cover body 20, it is possible to enable pages of the holding sheet body 30, which holds the object to be held, to be viewed in double-page spread and three or more pages to be expanded in a row and viewed.

### [Cover Body]

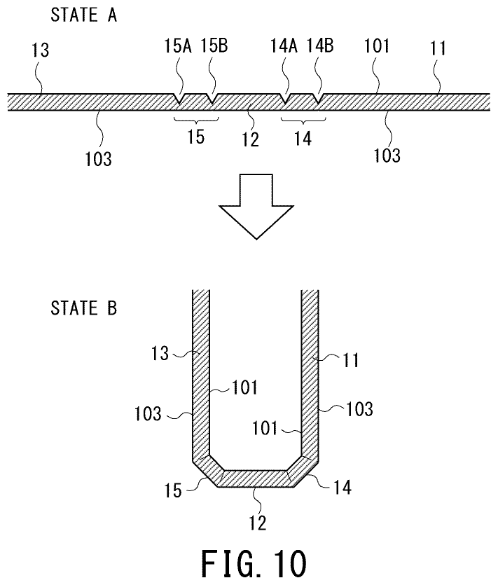

In the first cover body 10, a first cover section (a main cover section) 11, a second cover section 12, and a third cover section (a sub-cover section) 13 are connected via hinges 14 and 15. FIG. 10 is a schematic plan view illustrating the periphery of the hinges 14 and 15 of the first cover body 10. In FIG. 10, a state A indicates a state in which the first cover body 10 is opened and a state B indicates a state in which the first cover body 10 is closed. The first cover section 11, the second cover section 12, and the third cover section 13 in the present embodiment are respectively flat members formed of a resin material. The hinge 14 is provided at the boundary between the first cover section 11 and the second cover section 12. The hinge 15 is provided at the boundary between the second cover section 12 and the third cover section 13.

The hinge 14 includes two grooves 14A and 14B provided in the up-down direction on a first surface 101 of the first cover body 10. Similarly, the hinge 15 includes two grooves 15A and 15B provided in the up-down direction on the first surface (an inner side surface) 101 of the first cover body 10. Note that the first surface 101 is a surface directed to the inner side (the holding sheet body 30 side) of the file when the file 1 is closed. In the first cover body 10, a surface on the opposite side of the first surface 101, that is, a surface directed to the outer side of the file 1 when the file 1 is closed is a second surface 103. For example, the first cover body 10 may be a cover body in which grooves 14A, 14B, 15A, and 15B are formed on the first surface 101 of one resin flat plate along the up-down direction of the first surface 101 and portions where the grooves 14A, 14B, 15A, and 15B are formed are the hinges 14 and 15. In this first cover body 10, the thickness of the portions where the grooves 14A, 14B, 15A, and 15B are provided is thinner than the other portions. The first cover body 10 can be bent and stretched (opened and closed) with the portions as creases. For example, the first cover body 10 can take a posture (the state A in FIG. 10) in which the first cover section 11, the second cover section 12, and the third cover section 13 are opened along one plane. The first cover body 10 can take a posture (the state B in FIG. 10) in which the second cover section 12 is bent in a direction orthogonal to the first cover section 11 and the third cover section 13 is bent in a direction orthogonal to the second cover section 12. In the following description, setting the first cover body 10 in the posture of the state A is referred to as “open” as well and setting the first cover body 10 in the posture of the state B is referred to as “close” as well. Note that, in the example illustrated in FIG. 10, the hinges 14 and 15 respectively include two grooves 14A and 14B and two grooves 15A and 15B. However, not only this, but the number of grooves may be one or may be three or more. The hinges 14 and 15 are not limited to the configuration formed by the grooves 14A, 14B, 15A, and 15B. For example, when the first cover body 10 is made of paper, the first cover body 10 may be linearly compressed in the up-down direction and the hinges 14 and 15 may be configured using a compressed portion as a crease. When the first cover body 10 is formed of a material having high rigidity such as metal, the first cover section 11, the second cover section 12, and the third cover section 13 may be respectively formed as separate bodies and the first cover section 11, the second cover section 12, and the third cover section 13 may be coupled via hinges.

As illustrated in FIG. 9, on the outer side surface (the second surface) 103 of the first cover section 11, an auxiliary sheet 112 is stuck on a first end side 111 side on the opposite side of the hinge 14 in the left-right direction of the first cover section 11. In FIG. 9, the auxiliary sheet 112 is provided along the first end side 111 of the first cover section 11. However, not only this, but the auxiliary sheet 112 only has to be provided near an attachment position of a concave button 161 such that the concave button 161 can be attached. Note that, although the material of the auxiliary sheet 112 is not particularly limited, in the present embodiment, the same resin flat plate as the first cover section 11 is used. As described above, the thickness of the first cover body 10 in a portion where the auxiliary sheet 112 is provided over the first cover section 11 is thicker than the thickness of a portion of only the first cover section 11. Note that, in the present embodiment, since the auxiliary sheet 112 has the same thickness as the thickness of the first cover section 11, the thickness of the first cover body 10 in the portion where the auxiliary sheet 112 is provided is a double compared with the portion of only the first cover section 11.

The first cover body 10 includes a snap button that disengageably engages with the second cover body 20 each other. The snap button (a first button) provided in the first cover body 10 includes a concave button 161 and a convex button 162. In the present embodiment, two concave buttons 161 are disposed at an interval in the up-down direction of the first cover section 11 in a range in which the auxiliary sheet 112 is stuck in the first cover section 11. On the other hand, in the third cover section 13 of the first cover body 10, two convex buttons 162 are disposed at an interval in the up-down direction. In the third cover section 13, a slide groove 131 for slidably holding the convex button 162 is provided. The slide groove 131 is along hole piercing from the inner side to the outer side of the third cover section 13. The slide groove 131 is formed in the width direction of the third cover section 13, that is, a direction along the third cover section 13 and in a direction orthogonal to the up-down direction of the third cover section 13.

The second cover body 20 includes a first cover section (a main cover section) 21, a second cover section 22, a third cover section (a sub-cover section) 23, hinges 24 and 25, a concave button 261, a convex button 262, and an auxiliary sheet 212. Note that the concave button 261 and the convex button 262 are a second button in the present embodiment. The second cover body 20 in the present embodiment has the same shape as the shape of the first cover body 10. Structures and operations of the sections of the second cover body 20, for example, the first cover section 21, the second cover section 22, the third cover section 23, the hinges 24 and 25, the concave button 261, the convex button 262, and the auxiliary sheet 212 are the same as the structures and the operations of the first cover section 11, the second cover section 12, the third cover section 13, the hinges 14 and 15, the concave button 161, the convex button 162, and the auxiliary sheet 112 of the first cover body 10 described above. Therefore, redundant description thereof is omitted.

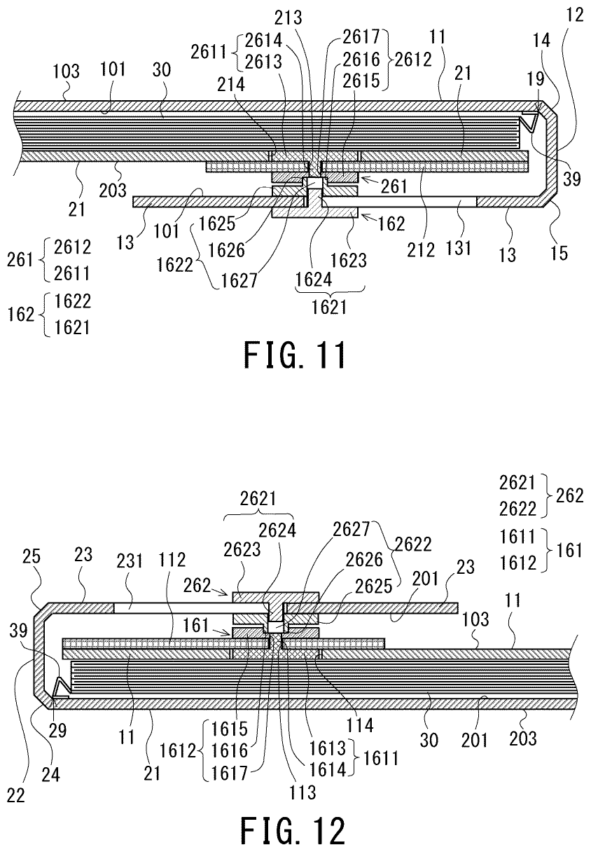

FIG. 11 is a schematic sectional view illustrating the vicinity of an attachment position of the convex button 162 of the first cover body 10 and the concave button 261 of the second cover body 20. The convex button 162 of the first cover body 10 includes an exterior section 1621 and an inner side engaging section 1622. The exterior section 1621 is attached to the outer side of the third cover section 13 and includes a generally disk-shaped flange section 1623 and a rod section 1624 for coupling. In the exterior section 1621, the rod section 1624 is erected in the center of a surface (an inner side surface) on a side in contact with the third cover section 13. The inner side engaging section 1622 is attached to the inner side of the third cover section 13 and includes a generally disk-shaped flange section 1625 and a cylindrical engaging protrusion 1626. In the flange section 1625, the engaging protrusion 1626 is erected in the center of a surface (an inner side surface) on the opposite side of a surface (an outer side surface) on a side in contact with the third cover section 13. On the inner side of the engaging protrusion 1626, a coupling hole 1627 piercing to the outer side surface of the flange section 1625 is provided. The inner side engaging section 1622 is disposed in a state in which the position of the coupling hole 1627 and the position of the slide groove 131 in the third cover section 23 are aligned and the outer side surface of the flange section 1625 is brought into contact with the first surface 101 of the third cover section 13. The rod section 1624 is inserted through the slide groove 131 of the third cover section 13 and the tip of the rod section 1624 is fit in the coupling hole 1627 of the inner side engaging section 1622, where by the exterior section 1621 is coupled to the inner side engaging section 1622. Accordingly, the flange section 1623 of the exterior section 1621 and the flange section 1625 of the inner side engaging section 1622 clamp the third cover section 13 and the convex button 162 is attached to the third cover section 13. Here, the convex button 162 is capable of moving along the slide groove 131 because the rod section 1624 is fit in the slide groove 131. That is, the convex button 162 and the third cover section 13 are capable of relatively sliding.

The concave button 261 of the second cover body 20 includes an inner side member 2611 and an outer side engaging member 2612. The inner side member 2611 includes a generally disk-shaped flange section 2613 and a coupling rod section 2614. In the inner side member 2611, the rod section 2614 is erected in the center of a surface on a side in contact with the auxiliary sheet 212. The outer side engaging member 2612 is attached to the outer side of the auxiliary sheet 212 and includes a generally disk-shaped flange section 2615. In the flange section 2615, an engaging recess 2616 is provided in the center of the outer side surface and a coupling hole 2617 is provided in the center of the inner side surface. Note that, in the first cover section 21 of the second cover body 20, at a position where the concave button 261 is attached, a circular hole is provided to pierce from the inner side to the outer side of the first cover section 21 as a housing section 214 for the inner side member 2611. In the auxiliary sheet 212, an attachment hole 213, through which the rod section 2614 is inserted, is provided coaxially with the housing section 214. The outer side engaging member 2612 is disposed in a state in which the position of the coupling hole 2617 and the position of the attachment hole 213 in the auxiliary sheet 212 are aligned and the inner side surface of the flange section 2615 is brought into contact with the outer side surface of the auxiliary sheet 212. The rod section 2614 is inserted into the housing section 214 of the first cover section 21 and the attachment hole 213 of the auxiliary sheet 212 and the tip of the rod section 2614 is fit in the coupling hole 2617 of the outer side engaging member 2612, whereby the inner side member 2611 is coupled to the outer side engaging member 2612. Accordingly, the auxiliary sheet 212 is clamped by the flange section 2613 of the inner side member 2611 and the flange section 2615 of the outer side engaging member 2612 and the concave button 261 is fixed to the first cover section 21 via the auxiliary sheet 212. At this time, since the flange section 2613 of the inner side member 2611 is housed in the housing section 214 of the first cover section 21, the flange section 2613 is prevented from projecting to the inner side of the first cover section 21. Note that the configuration in which the concave button 261 is attached to the auxiliary sheet 212 and the inner side member 2611 is housed in the housing section 214 is not essential. The auxiliary sheet 212 and the housing section 214 may be omitted and the concave button 261 may be directly attached to the first cover section 21.

In the convex button 162 of the first cover body 10, the engaging protrusion 1626 of the inner side engaging section 1622 disengageably engages with the engaging recess 2616 in the concave button 261 of the second cover body 20. In the present embodiment, a pair of the convex button 162 and the concave button 261 is referred to as button pair 16 as well. The first cover body 10 and the second cover body 20 are capable of taking a state of being coupled by the button pair 16 (162 and 261) and a state of being separated. Since the convex button 162 of the first cover body 10 is movable relatively to the third cover section 13 along the slide groove 131, when the convex button 162 of the first cover body 10 and the concave button 261 of the second cover body 20 engage, the second cover body 20 to which the concave button 261 is fixed and the first cover body 10 including the third cover section 13 are capable of relatively moving along the slide groove 131. In the present embodiment, the snap button provided in the third cover section 13 is the convex button 162 and the snap button provided in the first cover section 21 is the concave button 261. However, not only this, but the snap button provided in the third cover section 13 may be a concave button and the snap button provided in the first cover section 21 may be a convex button.

FIG. 12 is a schematic sectional view illustrating the vicinity of an attachment position of the convex button 262 of the second cover body 20 and the concave button 161 of the first cover body 10. Note that the convex button 262 and the concave button 161 have the same shapes as the shapes of the convex button 162 and the concave button 261 of the button pair 16. The exterior section 2621, the inner side engaging section 2622, the flange section 2623, the rod section 2624, the flange section 2625, the engaging protrusion 2626, the coupling hole 2627, the inner side member 1611, the outer side engaging member 1612, the flange section 1613, the rod section 1614, the flange section 1615, the engaging recess 1616, and the coupling hole 1617 in FIG. 12 are the same as the exterior section 1621, the inner side engaging section 1622, the flange section 1623, the rod section 1624, the flange section 1625, the engaging protrusion 1626, the coupling hole 1627, the inner side member 2611, the outer side engaging member 2612, the flange section 2613, the rod section 2614, the flange section 2615, the engaging recess 2616, and the coupling hole 2617 in FIG. 11. Therefore, redundant description thereof is omitted.

In the convex button 262 of the second cover body 20, the engaging protrusion 2626 of the inner side engaging section 2622 disengageably engages with the engaging recess 1616 in the concave button 161 of the first cover body 10. In the present embodiment, a pair of the convex button 262 and the concave button 161 is referred to as button pair 26 as well. The first cover body 10 and the second cover body 20 are capable of taking a state of being coupled by the button pair 26 (262 and 161) and a state of being separated. Since the convex button 262 of the second cover body 20 is movable relatively to the third cover section 23 along the slide groove 231, when the convex button 262 of the second cover body 20 and the concave button 161 of the first cover body 10 engage, the first cover body 10, to which the concave button 161 is fixed, and the second cover body 20 including the third cover section 23 are capable of relatively moving along the slide groove 231. In the present embodiment, the snap button provided in the third cover section 23 is the convex button 262 and the snap button provided in the first cover section 11 is the concave button 161. However, not only this, but the snap button provided in the third cover section 23 may be a concave button and the snap button provided in the first cover section 11 may be a convex button.

The button pair 16 and portions (the slide groove 131 and the like) of the first cover body 10 and the second cover body 20 to which the button pair 16 is attached constitute a first engaging section in the present embodiment. The button pair 26 and portions (the slide groove 231 and the like) of the first cover body 10 and the second cover body 20 to which the button pair 26 is attached constitute a second engaging section in the present embodiment. Note that the button pair 16 (162 and 261) is a form of a first engaging member. The button pair 26 (262 and 161) is a form of a second engaging member. The engaging member is not limited to the snap button and may be a member that engaging the first cover body 10 and the second cover body 20 using a snap fastener, a hook and loop fastener, a magnet, or the like. The slide grooves 131 and 231 and the convex buttons 162 and 262 constitute a moving mechanism in the present embodiment. Note that, in the present embodiment, the slide grooves 131 and 231 are provided in the third cover sections 13 and 23. However, not only this, but attachment holes 113 and 213 in the auxiliary sheets 112 and 212 and housing sections 114 and 214 in the first cover sections 11 and 21 may be slide grooves (long holes) and the concave buttons 161 and 261 may be configured to move along the attachment holes 113 and 213 and the housing sections 114 and 214. Pluralities of the concave buttons 161 and 261 may be provided in the moving direction in the first cover section 11 and the moving mechanism may be configured to relatively move the first cover body 10 and the second cover body 20 by changing the concave buttons 161 and 261 to which the convex buttons 162 and 262 of the third cover sections 13 and 23 are attached. A hook and loop fastener may be used as the engaging section and the moving mechanism may be configured to relatively move the first cover body 10 and the second cover body 20 by changing a position where the hook and loop fastener is engaged.

### [Holding Sheet Body]

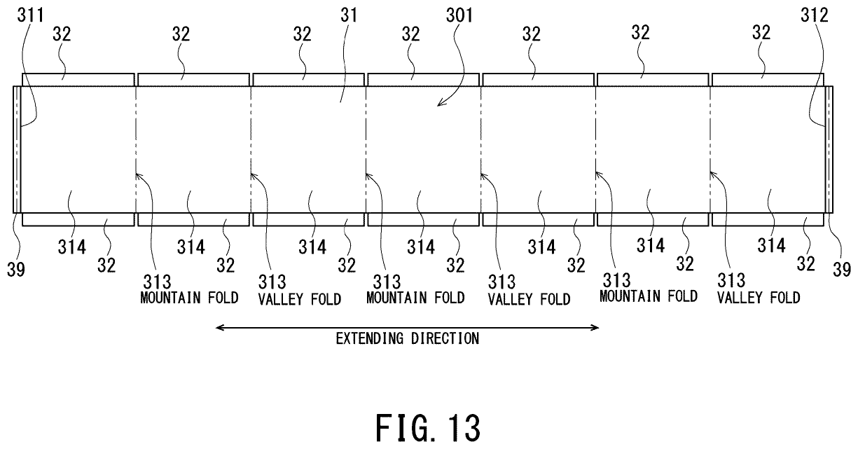

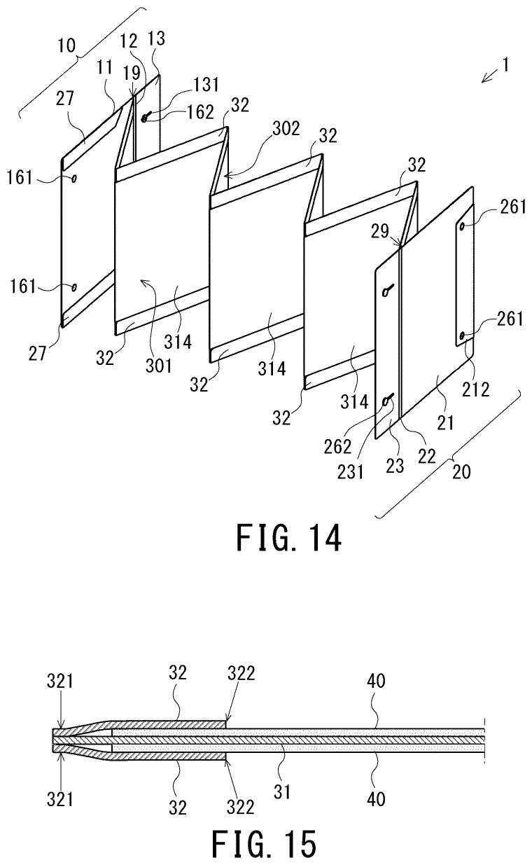

FIG. 13 is a diagram illustrating an expanded state of the holding sheet body 30 and FIG. 14 is a diagram illustrating the file 1 halfway in being expanded. As illustrated in FIG. 13, the holding sheet body 30 includes a belt-like base sheet (a sheet section) 31 extended in one direction (an extending direction) and a holding section 32 that causes the base sheet 31 to hold an object to be held such as a document. Both end portions in the extending direction of the base sheet 31 include connecting sections 39 that connect the holding sheet body 30 to the first cover body 10 or the second cover body 20. In FIG. 13, a first surface 301 that holds the object to be held in the holding sheet body 30 is illustrated. The holding sheet body 30 includes the holding section 32 at least on the first surface 301 side of the base sheet 31, and the object to be held is held along the first surface 301 of the base sheet 31. The holding sheet body 30 in the present embodiment includes the holding section 32 also on a second surface 302 located on the opposite side of the first surface 301 in the base sheet 31. The object to be held can also be held on the second surface 302 side of the base sheet 31. The holding section 32 in the present embodiment is the same sheet as the base sheet 31 and is joined to the upper and lower ends of the base sheet 31 respectively by a method such as bonding or welding. FIG. 15 is a schematic sectional view of the vicinity of the holding section 32 illustrating a state in which an object to be held 40 is held. In the holding section 32 provided in an upper part of the base sheet 31, a part 321 on the upper end side is joined to the base sheet 31 and the lower end 322 side is not joined. Therefore, the holding section 32 can hold the object to be held 40 inserted between the holding section 32 and the base sheet 31 from the lower end (a free end) 322 side. In the holding section 32 provided in a lower part of the base sheet 31, similarly, a part on the lower end side is joined to the base sheet 31. The holding section 32 can hold the object to be held 40 inserted between the holding section 32 and the base sheet 31 from the upper end (free end) side.

In the base sheet 31, one end portion 311 is connected to the first cover section 11 of the first cover body 10 via the connecting section 39 and the other end portion 312 is connected to the first cover section 21 of the second cover body 20 via the connecting section 39. For example, the one end portion 311 of the base sheet 31 is connected to the first cover section 11 in the up-down direction at a position near the hinge 14 of the first cover body 10. The other end portion 312 of the base sheet 31 is connected to the first cover section 21 in the up-down direction at a position near the hinge 24 of the second cover body 20.

In the base sheet 31, a plurality of creases 313 in a direction orthogonal to the extending direction, the direction being a direction (the up-down direction) along the surfaces 301 and 302 that hold the object to be held, are provided at substantially equal intervals in the extending direction. The base sheet 31 is folded in so-called bellows fold such that, among the plurality of creases 313, creases folded to the paper surface near side in FIG. 13 (mountain fold) and creases folded to the paper surface depth side in FIG. 13 (valley fold) are alternately arranged. In other words, the base sheet 31 is folded like bellows such that creases folded to cause surfaces of the second surface 302 to face each other (mountain fold) and creases folded to cause surfaces of the first surface 301 to face each other (valley fold) are alternately formed. The base sheet 31 is a flexible thin sheet and is capable of transitioning to a folded state illustrated in FIG. 11 and an expanded state in which the creases 313 are folded back (expanded) as illustrated in FIG. 13. In the base sheet 31 in the folded state, regions 314 divided by the creases 313 of the base sheet 31 are laid one on top of another to be substantially parallel. In the present embodiment, the holding section 32 are respectively provided in the regions 314 of the base sheet 31. The object to be held can be held in each of the regions 314. In the following description, the regions 314 divided by the creases 313 of the base sheet 31 (the holding sheet body 30) are referred to as pages as well. In the example illustrated in FIG. 12, the holding sheet body 30 is folded at six mountains of so-called bellows fold and the first surface 301 and the second surface 302 are each divided into seven pages. Note that the number of pages of the holding sheet body 30 is not particularly limited and only has to be plural. The width (the length in the extending direction) and the height (the length in the up-down direction) of the pages may be set according to a size of standard paper such as A4 or B5. For example, in the file 1 in the present embodiment, the width and the height of the pages are set such that the A4 size paper is fit in one page. For this reason, it is possible to hold the A3 size paper in (across) two pages.

### Use Examples

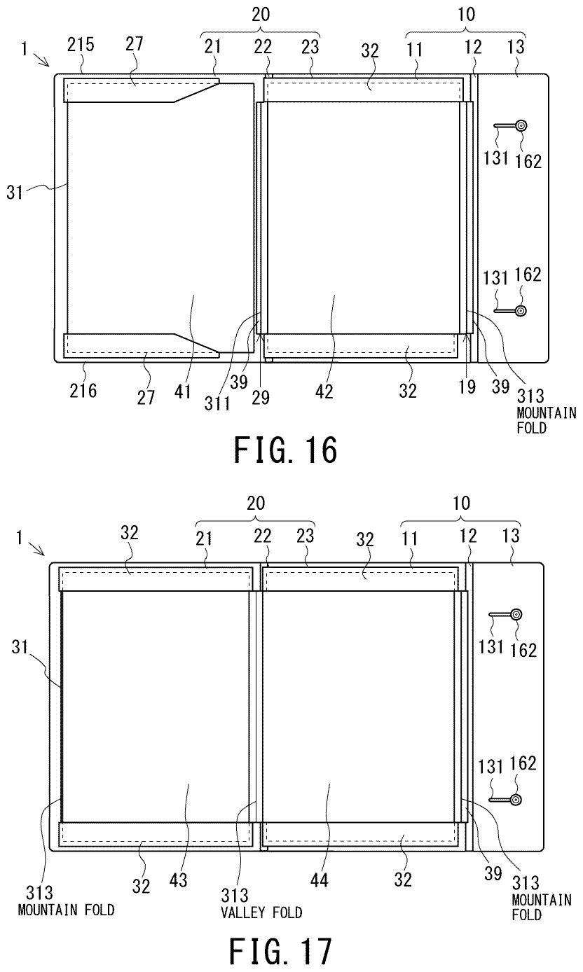

FIG. 16 is a diagram illustrating the file 1 changed from a state in which the file 1 is closed to a state in which the second cover body 20 is opened and FIG. 17 is a diagram illustrating a state in which the holding sheet body is opened in double-page spread. For example, as illustrated in FIG. 5, the holding sheet body 30 is folded, the first cover section 11 of the first cover body 10 is disposed along the back of the holding sheet body 30 and the first cover section 21 of the second cover body 20 is disposed along the front of the holding sheet body 30, the button pair 16 (162 and 261) and the button pair 26 (262 and 161) are engaged, and the file 1 at the nonviewing time is brought into a closed state. Accordingly, the first cover body 10 and the second cover body 20 are coupled to each other and surround the holding sheet body 30 in the folded state. Therefore, it is possible to prevent the holding sheet body 30 from being suddenly expanded and prevent the holding sheet body 30 and the object to be held from being damaged by an external factor.

For example, when the button pair 16 (162 and 261) is disengaged from the closed state illustrated in FIG. 5, it is possible to open the second cover body 20 as illustrated in FIG. 16. In an example illustrated in FIG. 16, the first cover section 11 of the first cover body 10 and the first cover section 21 of the second cover body 20 are opened along the same plane as in the case in which the file 1 is placed on a desk or a bookrest. In this case, the interval between a connection part 19 of the first cover body 10, to which one end of the holding sheet body 30 is connected, and a connection part 29 of the second cover body 20, to which the other end of the holding sheet body 30 is connected, is adjusted to decrease by a moving mechanism. Note that details of the adjustment by the moving mechanism are described below.

In FIG. 16, the holding sheet body 30 is disposed with the first surface 301 directed to the user side (the opposite side of the cover body) to make it possible to show, to the user, an object to be held 42 held on a page closest to the user side on the first surface 301. A holding section 27 is provided along an upper side 215 and a lower side 216 on the first surface 201 of the first cover section 21. The holding section 27 is the same sheet as the holding section 32 of the holding sheet body 30 and is joined to respectively the upper and lower ends of the first cover section 21 by a method such as bonding or welding. For this reason, in the state illustrated in FIG. 16, the object to be held 41 held by the holding section 27 of the first cover section 21 can be visually recognized from the user in double-page spread together with the object to be held 42 held by the holding sheet body 30. Note that, in FIG. 16, portions of the objects to be held 41 and 42 sandwiched by the holding sections 32 and 27 are indicated by broken lines. However, in the present embodiment, since the holding sections 32 and 27 are formed of a transparent material, patterns drawn in the portions (the broken line portions) covered by the holding sections 32 and 27 can also be visually recognized through the holding sections 32 and 27. In FIG. 16, the holding section 27 provided in the first cover section 21 of the second cover body 20 is illustrated. However, the holding section 27 is also provided in the first cover section 11 of the first cover body 10.

In the holding sheet body 30 in the folded state, like turning a page of a booklet, the crease 313 corresponding to a fore-edge of each page is moved to a position symmetrical with respect to an axis that is the crease 313 located on a spine side of the page, whereby the next page can be opened as illustrated in FIG. 17. In the following description, this operation is simply referred to as turning the page as well.

In the state illustrated in FIG. 17, two pages in the holding sheet body 30 are disposed side by side on the left and right such that the objects to be held 43 and 44 held by the page can be viewed in double-page spread. Similarly, when pages of the holding sheet body 30 are turned, the objects to be held 43 and 44 held by a page located on the outermost side can be viewed in double-page spread. That is, when the second cover body 20 is opened in a state in which the convex button 262 of the second cover body 20 and the concave button 161 of the first cover body 10 are engaged and the convex button 162 of the first cover body 10 and the concave button 261 of the second cover body 20 are disengaged as illustrated in FIG. 8, FIG. 16, and FIG. 17, among objects to be held by pages on the first surface 301 of the holding sheet body 30 and by the first surface 201 of the first cover section 21, two objects to be held located on the outermost side by page turning can be viewed in double-page spread. When the first cover body 10 is opened in a state in which the convex button 162 of the first cover body 10 and the concave button 261 of the second cover body 20 are engaged and the convex button 262 of the second cover body 20 and the concave button 161 of the first cover body 10 are disengaged as illustrated in FIG. 9, among objects to be held held by pages on the second surface 302 of the holding sheet body 30 and by the first surface 101 of the first cover section 11, two objects to be held located on the outermost side by page turning can be viewed in double-page spread.

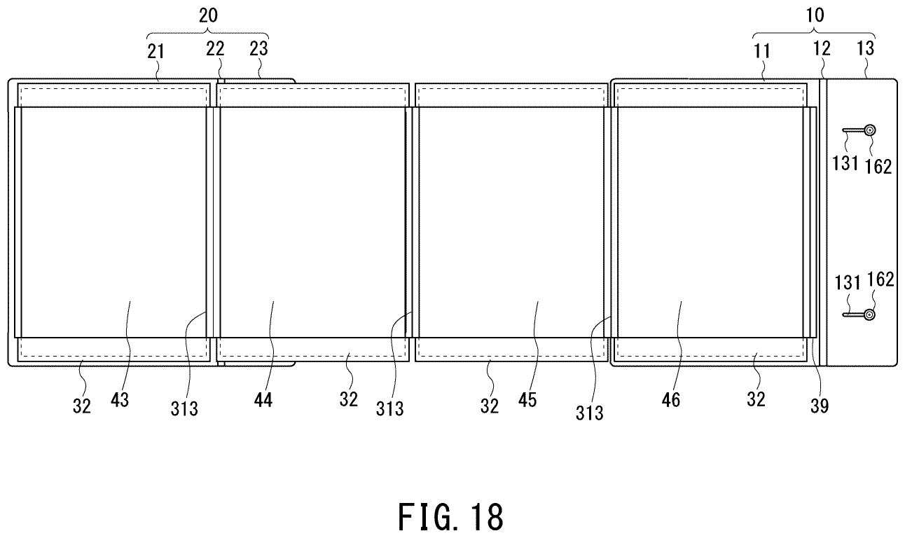

FIG. 18 is a diagram illustrating a state in which the first cover body 10 and the second cover body 20 are disengaged and the holding sheet body 30 is expanded. In FIG. 18, four pages of the holding sheet body 30 are arranged side by side on the left and right. Accordingly, the objects to be held 43 to 46 for four pages held by the pages can be viewed as a list. As described above, the file 1 in the present embodiment is suitable to holding objects to be held for which pages more than two pages in double-page spread are desired to be viewed as a list because desired pages can be expanded and viewed. For example, when musical scores are held in pages, even if musical scores used in one performance are three pages or more, pages holding the musical scores before the performance are expanded to make it possible to view the musical scores used in one performance as a list. Accordingly, it is possible to eliminate a trouble of a user turning pages during a performance.

### [Relative Movement of the First Cover Body and the Second Cover Body by the Moving Mechanism]

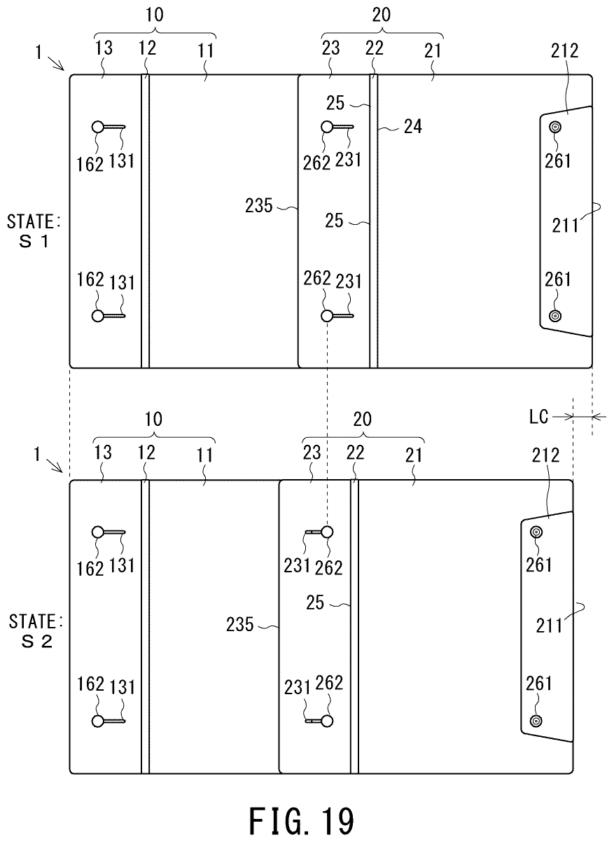

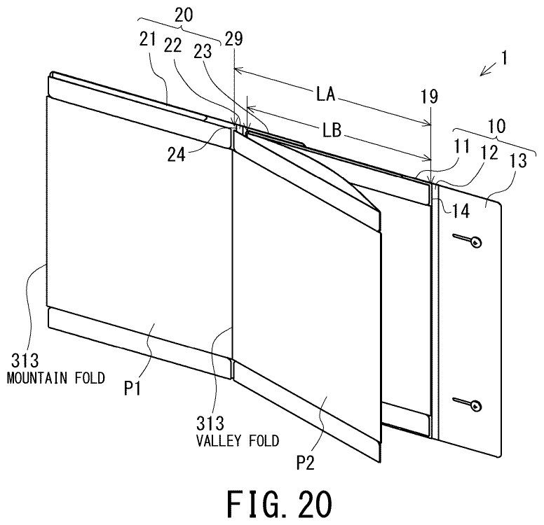

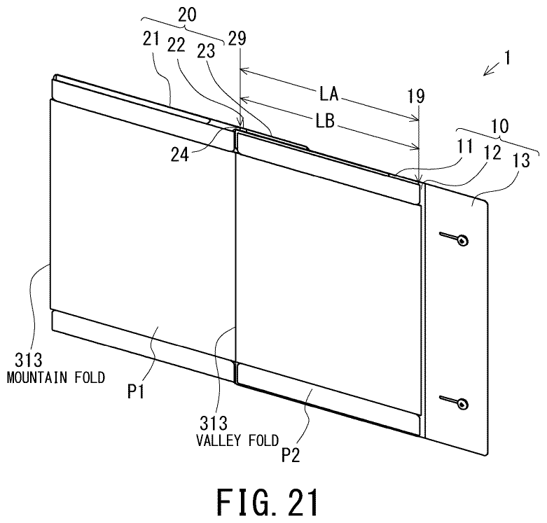

In the file 1 in the present embodiment, the first cover body 10 and the second cover body 20 are relatively movable by the moving mechanism (a slide mechanism) configured from the slide grooves 131 and 231 and the convex buttons 162 and 262. FIG. 19 is a diagram illustrating a state in which the first cover body 10 and the second cover body 20 are relatively moved by the moving mechanism, FIG. 20 is a diagram illustrating a state before the first cover body 10 and the second cover body 20 are relatively moved by the moving mechanism when the file is opened, and FIG. 21 is a diagram illustrating a state after the first cover body 10 and the second cover body 20 are relatively moved by the moving mechanism when the file is opened.

In a state in which the file is closed and both of the button pair 16 and the button pair 26 are engaged as illustrated in FIG. 2 and FIG. 6, the first cover body 10 and the second cover body 20 are disposed to surround the outer periphery of the holding sheet body 30 in the folded state as illustrated in FIG. 4 and FIG. 5. The first cover body 10 and the second cover body 20 are formed a size larger than the holding sheet body 30 in the folded state such that the first cover body 10 and the second cover body 20 can protect the holding sheet body 30 at this time. However, the width and the height of the first cover body 10 and the second cover body 20 are set to values close to the width and the height in the holding sheet body 30 in the folded state such that the holding sheet body 30 fits perfectly on the inner side of the first cover body 10 and the second cover body 20 without waste. For example, the length (the left-right width) from the first end sides 111 and 211 of the first cover sections 11 and 21 to the hinges 14 and 24 is length close to the width of pages in the holding sheet body 30. The length in the depth direction in the second cover sections 12 and 22 is length close to the length (the back width) in the depth direction in the holding sheet body 30 in the folded state. When the first cover body 10 and the second cover body 20 having a relation of the lengths described above are closed as illustrated in FIG. 2 and FIG. 6, the convex buttons 162 and 262 forming the moving mechanism are located at the end portions on the second end sides 135 and 235 side of the third cover section 13 in the slide grooves 131 and 231. When the convex button 162 of the first cover body 10 and the concave button 261 of the second cover body 20 are disengaged from this state and the first cover section 11 of the first cover body 10 and the first cover section 21 of the second cover body 20 are opened along the same plane as illustrated in FIG. 20, length (an interval) LA in the left-right direction from the connection part 19 in the first cover section 11 of the holding sheet body 30 to the connection part 29 in the first cover section 21 of the holding sheet body 30 is larger than length (width) LB of one page in the left-right direction of the holding sheet body 30. For example, since the interval LA between the connection parts 19 and 29 at this time includes the lengths of the second cover section 22 and the hinges 24 and 25 in addition to the length of the first cover section 11, the interval LA is longer than the width LB of one page in the holding sheet body 30. In this case, a page turned to the first cover section 21 side of the second cover body 20 is stacked on the first cover section 21 starting from the connection part 29 and a page on the first cover section 11 is stacked starting from the connection part 19. Therefore, these pages are stacked with a gap by the difference between the interval LA between the connection parts 19 and 29 and the width LB of the page. For this reason, when a page P1 is turned to the first cover section 21 side from the first cover section 11, the crease 313 forming the boundary between the page P1 and a page P2 adjacent on the first cover section 11 side (the right side in FIG. 20) is pulled to the connection part 29 side. For this reason, the pulled page P2 turns up and falls into a state of being less easily visually recognized or a state of description for an object to be held being difficult, and convenience is deteriorated.

In contrast, in the file 1 in the present embodiment, the first cover body 10 and the second cover body 20 are relatively movable by the moving mechanism. The first cover body 10 and the second cover body 20 can be moved to draw each other to change from a state S1 to a state S2 illustrated in FIG. 19 when the file 1 is opened. In FIG. 19, the state S1 indicates a state in which the convex button 262 forming the moving mechanism is located at the end portion on the second end side 235 side in the slide groove 231, that is, a state illustrated in FIG. 20. On the other hand, in FIG. 19, the state S2 indicates a state in which the convex button 262 forming the moving mechanism is located at the end portion on the hinge 25 side in the slide groove 231, that is, a state illustrated in FIG. 21. As described above, the moving mechanism in the present embodiment can reduce the length (the width) in the left-right direction of the first cover body 10 and the second cover body 20 by a distance LC equivalent to the length of the slide grooves 131 and 231 by relatively moving the first cover body 10 and the second cover body 20 to change from the state S1 to the state S2.

As illustrated in FIG. 21, when the interval LA between the connection parts 19 and 29 and the page width LB of the holding sheet body 30 are made substantially equal by the relative movement of the first cover body 10 and the second cover body 20, a page on the first cover section 11 and a page on the second cover section are stacked without gaps on the left and right. When a page is turned, the next page is not pulled and the page is prevented from turning up. Note that, in FIG. 19 to FIG. 21, an example is illustrated where, in a state in which the first cover body 10 and the second cover body 20 are engaged by the button pair 26, the first cover body 10 and the second cover body 20 are relatively moved by the moving mechanism formed by the convex button 262 and the slide groove 231. However, as illustrated in FIG. 9, similarly, when the first cover body 10 and the second cover body 20 are engaged by the button pair 16, the first cover body 10 and the second cover body 20 are relatively moved by the moving mechanism formed by the convex button 162 and the slide groove 131. That is, in the file in the present embodiment, when the first cover body 10 and the second cover body 20 are engaged by the button pair 16 and the first cover section 11 and the first cover section 21 are opened along the same plane as illustrated in FIG. 9, the interval LA between the connection part 19 of the holding sheet body 30 to the first cover section 11 and the connection part 29 of the holding sheet body 30 to the first cover section 21 is adjusted to substantially the same length as the page width LB by the moving mechanism formed by the convex button 162 and the slide groove 131, whereby a page is prevented from turning up.

As described above, according to the present embodiment, in the file 1 capable of transitioning to the expanded state and the folded state, it is possible to improve convenience in the folded state.

### <Modification 1>

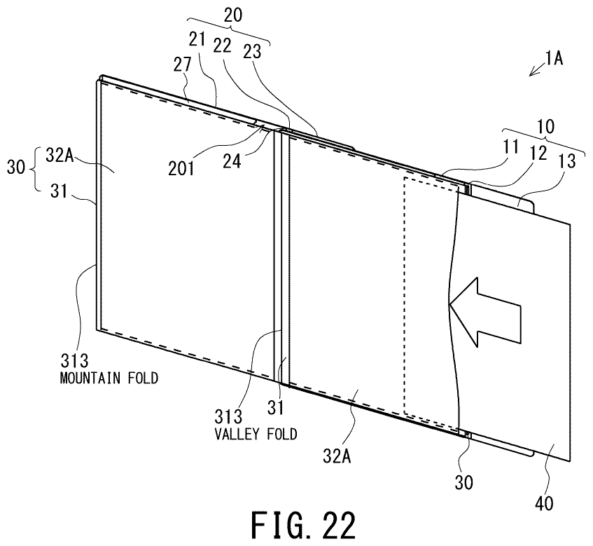

FIG. 22 is a diagram illustrating a configuration of a file 1A according to a modification 1. In the present modification, compared with the embodiment described above, a configuration of the holding section 32 is the different and the other configurations are the same. For this reason, redundant description is omitted by, for example, denoting the same elements with the same reference numerals and signs.

As illustrated in FIG. 22, a holding section 32A in the file 1A is provided across the upper and lower ends of pages to generally cover the surfaces of the pages in the holding sheet body 30. The upper and lower ends of the holding section 32A are respectively joined to the upper and lower ends of the base sheet 31 by a method such as bonding or welding. The left and right ends of the holding section 32A are not joined. For this reason, the holding section 32A can hold the object to be held 40 inserted between the holding section 32A and the base sheet 31 from the left and right end sides. Note that, since the holding section 32A in the present modification is formed of a transparent material, the object to be held 40 held between the holding section 32A and the base sheet 31 can be visually recognized through the holding section 32A. Note that the holding section 32A is not limited to a configuration in which the upper and lower ends are joined to the base sheet 31 and may have a configuration in which three sides among the upper, lower, left, and right four sides in one page of the holding sheet body 30 are joined to the base sheet 31. Note that, like the holding section 32A, the holding section 27 provided on the first surfaces 101 and 201 of the first cover sections 11 and 21 may be provided to cover the first surface 201 across the upper and lower ends of the first cover sections 11 and 21.

As described above, since the holding section 32 is provided across the upper and lower ends of the file 1A, the file 1A in the present modification can hold even a small object to be held that does not have a standard size.

### <Modification 2>

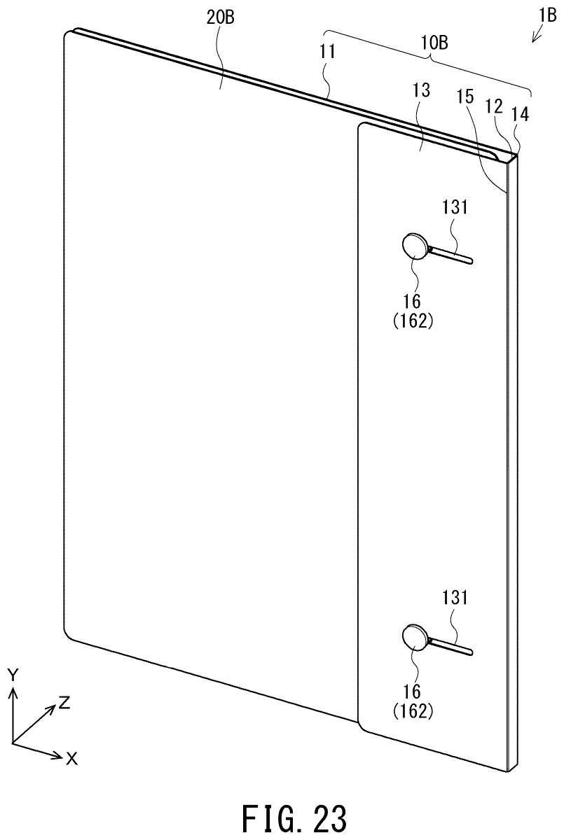

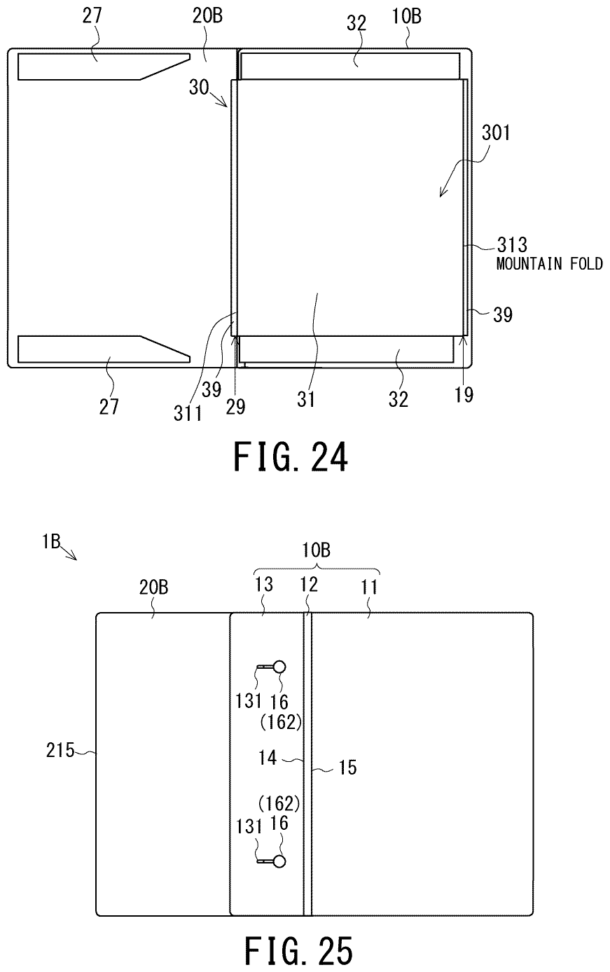

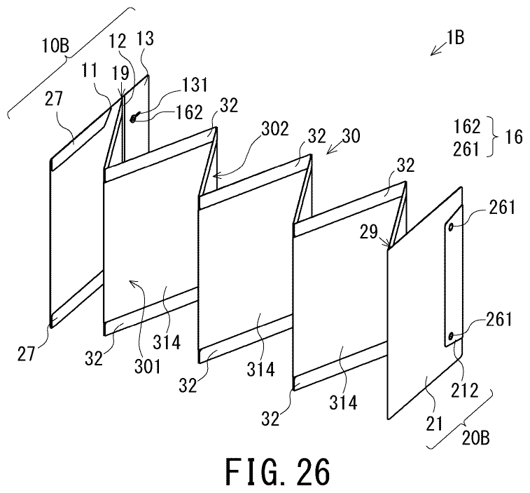

FIG. 23 is a diagram illustrating a configuration of a file 1B according to a modification 2, FIG. 24 is a diagram illustrating a state in which the inner side (a side where the holding sheet body 30 is provided) of the file 1B according to the modification 2 is opened, FIG. 25 is a diagram illustrating an outer side surface (a second surface) in the case in which the file 1B according to the modification 2 is opened, and FIG. 26 is a perspective view illustrating a state halfway in undoing the button pair 16 of the file 1B to expand the file 1B. In the present modification, compared with the embodiment described above, a configuration of a cover body is different and the other configurations are the same. For this reason, redundant description is omitted by denoting the same elements with the same reference numerals and signs.

The file 1B includes a first cover body 10B, a second cover body 20B, and the holding sheet body 30. Compared with the first cover body 10 in the embodiment described above, the first cover body 10B has a configuration in which the concave button 161, the auxiliary sheet 112, and the housing section 114 are omitted. Compared with the second cover body 20 in the embodiment described above, the second cover body 20B in the present modification has a configuration in which the second cover section 22, the third cover section 23, and the hinges 24 and 25 are omitted. In other words, the second cover body 20B has a configuration equivalent to a configuration in which the first cover section 21 is provided alone in the embodiment described above.

In an example illustrated in FIG. 23 to FIG. 25, in the file 1B, the first cover body 10B and the second cover body 20B are engaged by the button pair 16 and the first cover body 10B and the second cover body 20B can be opened and closed by the hinges 14 and 15. In this case, a configuration in which the first cover body 10B and the second cover body 20B are relatively moved by the moving mechanism formed by the convex button 162 and the slide groove 131 is the same as the configuration in the embodiment described above. A page is prevented from turning up when pages of the holding sheet body 30 are shown in double-page spread. A configuration in which the holding sheet body 30 can be expanded when the button pair 16 is disengaged in the file 1B as illustrated in FIG. 26 is also the same as the configuration in the embodiment described above.

According to the present modification, compared with the embodiment described above, even in a simple configuration in which a part of a cover body is omitted, it is possible to achieve convenience improvement in the folded state while enabling the holding sheet body 30 to transition to the folded state and the expanded state.

### <Others>

The components, the combinations of the components, and the like in the embodiment and the modifications described above are examples, and addition, omission, substitution, and other changes of components are possible within a scope not departing from the gist of the present disclosure. The present disclosure is not limited by the embodiment and is limited only by the claims.

### REFERENCE SIGNS LIST

1, 1A, 1B: File
10, 10B: First cover body
11, 21: First cover section
12, 22: Second cover section
13, 23: Third cover section
14,24,15,25: Hinge
16, 26: Button pair
20, 20B: Second cover body
27: Holding section
30: Holding sheet body
31: Base sheet
32, 32A: Holding section
39: Connecting section
100: Cover body
112, 212: Auxiliary sheet
113, 213: Attachment hole
114: Housing section
131, 231: Slide groove
214: Housing section
313: Crease
314: Region

1. A file comprising:
a holding sheet body including a sheet section extended in one direction and including a holding section configured to cause the sheet section to hold an object to be held;
a first cover body to which one end in an extending direction of the sheet section is connected;
a second cover body to which another end in the extending direction of the sheet section is connected; and
a first engaging section configured to engage the first cover body and the second cover body, wherein
a plurality of creases are provided in the sheet section in the extending direction, the plurality of creases extending in a direction orthogonal to the extending direction and along a surface that holds the object to be held, and the sheet section is capable of transitioning to a folded state of being folded like a bellows in the creases and an expanded state of being expanded with the creases folded back,
the first cover body includes a main cover section capable of closing along the holding sheet body in the folded state and a sub-cover section capable of opening and closing relatively to the main cover section, and
the first engaging section engages the second cover body and the sub-cover section in a state in which the sub-cover section is placed along the second cover body, and
the first engaging section includes a moving mechanism configured to enable relative movement of the first cover body and the second cover body to change a distance between a connection part of the holding sheet body in the first cover body and a connection part of the holding sheet body in the second cover body.

2. The file according to claim 1, wherein the first engaging section disengageably engages the first cover body and the second cover body.

3. The file according to claim 1, wherein
the second cover body includes a main cover section capable of closing along the holding sheet body in the folded state and a sub-cover section capable of opening and closing relatively to the main cover section, and
the file includes a second engaging section configured to engage the second cover body and the first cover body in a state in which the sub-cover section of the second cover body is placed along the main cover section of the first cover body.

4. The file according to claim 3, wherein
the second engaging section includes a second engaging member configured to engage the second cover body and the first cover body, and
the moving mechanism includes a slide groove provided in the sub-cover section in the second cover body in a width direction of the sub-cover section in the second cover body and configured to slidably hold the second engaging member.

5. The file according to claim 1, wherein
the first engaging section includes a first engaging member configured to engage the second cover body and the first cover body, and
the moving mechanism includes a slide groove provided in the sub-cover section in the first cover body in a width direction of the sub-cover section in the first cover body and configured to slidably hold the first engaging member.
